(19) United States
(12) Patent Application Publication
(10) Pub. No.: US 2011/0226763 A1
(43) Pub. Date: Sep. 22, 2011

(54) Folding container

(76) Inventor: German Valencia, Miami, FL (US)

(21) Appl. No.: 12/659,757

(22) Filed: Mar. 19, 2010

(51) Int. Cl. B65D 6/00; B31B 1/26

(52) U.S. Cl. 220/6; 493/243

(57) ABSTRACT

The folding container is formed from a single seamless sheet of liquid impervious material to form a container for liquids or bulk goods as desired. The sheet forming the container is folded along fixed fold lines, i.e., folds that remain permanently in place to define the various panels of the container, and hinge folds, i.e., folds along which the side and bottom panels may be spread to open the container for use or closed to fold the container for compact storage. The side and bottom panels fold inwardly between the front and rear panels of the container for storage, thus providing an even more compact configuration. The front, rear, and both side panels are configured as trapezoids, with their bases wider than their upper edges. This provides greater stability for the container when filled, due to the lower center of gravity of the mass contained therein and the wider base.

### BACKGROUND OF THE INVENTION

1. FIELD OF THE INVENTION

The present invention relates generally to portable containers for liquids and bulk goods, and particularly to a formed of a single flat sheet of liquid impervious material.

2. DESCRIPTION OF THE RELATED ART

The need for portable containers for the carriage and storage of liquids and loose bulk goods (e.g., rice, flour, etc.) has been known for centuries. This need has been met in the past with containers formed of pottery and finely woven materials (for non-liquid goods), and more recently by means of containers molded or otherwise formed of plastic, metal, and glass. While containers formed of ceramics, glass, metal, and plastic may certainly be made to be liquid impervious, they generally cannot be made to fold for compact storage unless significant additional work is carried out to seal the various edges along which the panels of the container fold or collapse.

Accordingly, most such containers are formed as relatively rigid shells that take up the same amount of space whether empty or full. Certain exceptions are known in which containers formed of plasticized or rubberized fabric or flexible plastic sheet materials can collapse for storage, e.g., plastic bags and the like. However, such flexible wall containers do not hold their shape when filled with a substance, and require additional structure to hold a desired shape other than the natural, generally spherical shape that forms when such a container is filled.

The present inventor is aware of certain folding and/or collapsible liquid containers that have been developed in the past. Japanese Patent No. 4-339,754, published on Nov. 26, 1992, which describes (according to the drawings and English abstract) a liquid container formed of a single sheet of paper and having plastic coating on both the external and internal surfaces. The device is formed as a sleeve with permanently folded and sealed bottom and side seams.

German Patent Publication No. 19,811,428 published on Jun. 17, 1999, describes (according to the drawings and English abstract) a folding drinking cup formed of plastic or paper sheet material. The device has a pair of mutually opposed sidewalls of trapezoidal shape. The upper edges of the device are folded down to form the drinking cup per se.

None of the above inventions and patents, taken either singly or in combination, is seen to describe the instant invention as claimed. Thus, a folding container solving the aforementioned problems is desired.

### SUMMARY OF THE INVENTION

The folding container is formed of a single seamless sheet of liquid impervious material, e.g., a semi-rigid sheet of plastic. The periphery of the sheet is formed to have the proper contours to define the upper edge of the container once the container has been constructed. Fixed fold lines or score lines, i.e., folds or scores along which permanent, unmoving folds are formed, are established on the sheet, and the sheet is permanently folded along these lines with portions of the sheet gathered to form a concave container. The upper edges are permanently secured by rivets or other suitable fasteners. Hinge fold or score lines, i.e., folds or scores along which the sheet is selectively folded for opening the container or folding the container flat for storage, are also established at the time of the formation of the fixed fold lines. The hinge fold lines allow the container to be folded to a flat and relatively thin configuration for storage, with two opposed sides and the bottom folding inwardly to minimize the space or volume required for the folded container.

Some of the hinge fold lines define trapezoidal shapes for each of the four faces or panels of the container, with the trapezoid faces or panels having relatively larger bases and narrower tops. This configuration results in a more stable container when a substance is carried therein, e.g., water or other liquid, etc., with the container not so likely to tip or spill due to its wider base and lower center of gravity.

These and other features of the present invention will become readily apparent upon further review of the following specification and drawings.

### BRIEF DESCRIPTION OF THE DRAWINGS

FIG. 1 is a front and top perspective view of a folding container according to the present invention, illustrating its general configuration in an expanded or deployed state.

FIG. 2 is a rear and bottom perspective view of the folding container according to the present invention in a partially folded state, showing the inwardly folding side and bottom panels.

FIG. 3 is a front elevation view of the folding container according to the present invention, showing the trapezoidal shape of the front panel.

FIG. 4 is a side elevation view of the folding container according to the present invention, showing the trapezoidal shape of the side panel.

FIG. 5 is a side elevation view of the folding container according to the present invention in its completely folded state.

FIG. 6 is a plan view of a flat pattern with fold lines for forming and folding the folding container according to the present invention.

FIG. 7 is a perspective view of the folding container according to the present invention in its partially completed state, showing the folding lines for forming the fixed and hinge folds of the container.

Similar reference characters denote corresponding features consistently throughout the attached drawings.

### DETAILED DESCRIPTION OF THE PREFERRED EMBODIMENT

The folding container is formed of a single seamless sheet of liquid impervious material, with the container providing for the carriage and/or storage of various liquid or dry bulk commodities, as desired. The specifically oriented fold lines of the sheet result in the four upright panels of the container having trapezoidal shapes, with narrower upper portions and wider lower portions. The resulting wider base or bottom of the container and the lower center of gravity when filled due to the greater volume in the lower portion, provide good stability for the container. The container folds along precisely predetermined lines, as opposed to merely collapsing randomly, to provide for compact shipment of the container and for storage of the container when not in use.

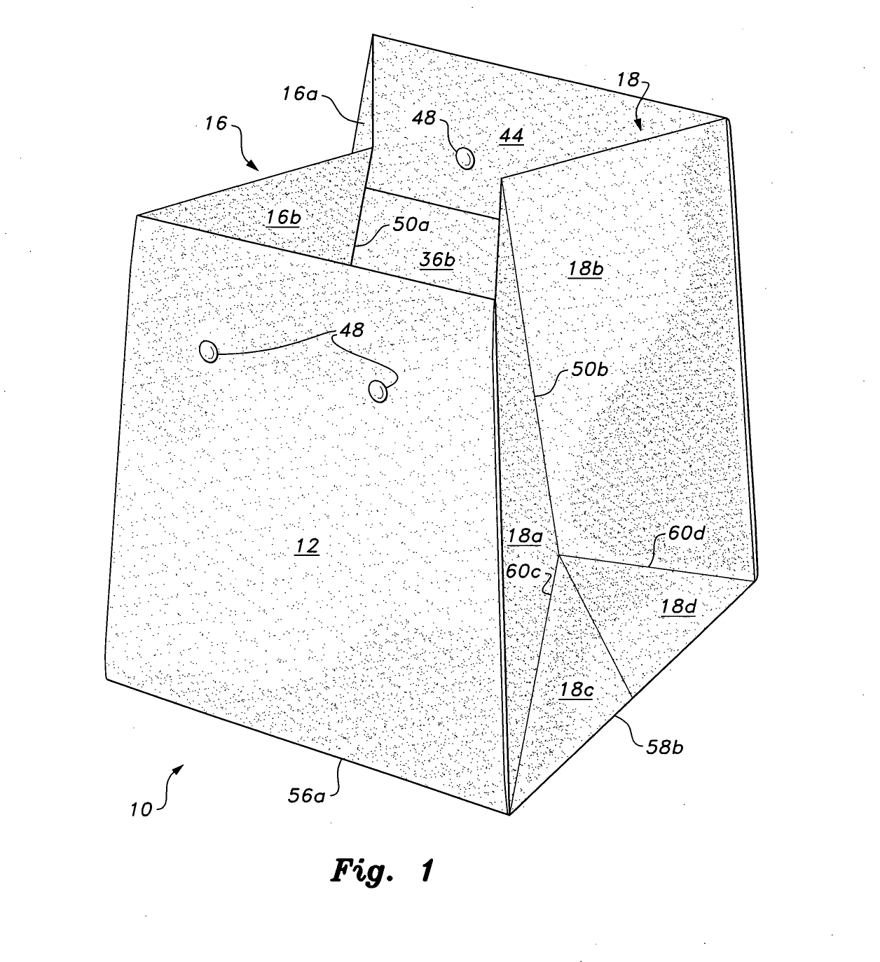

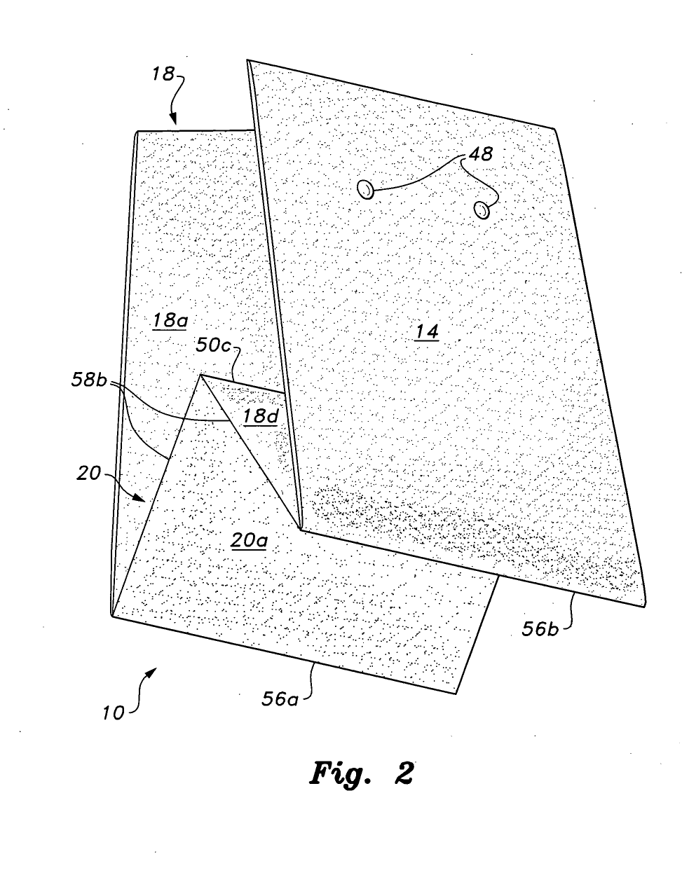

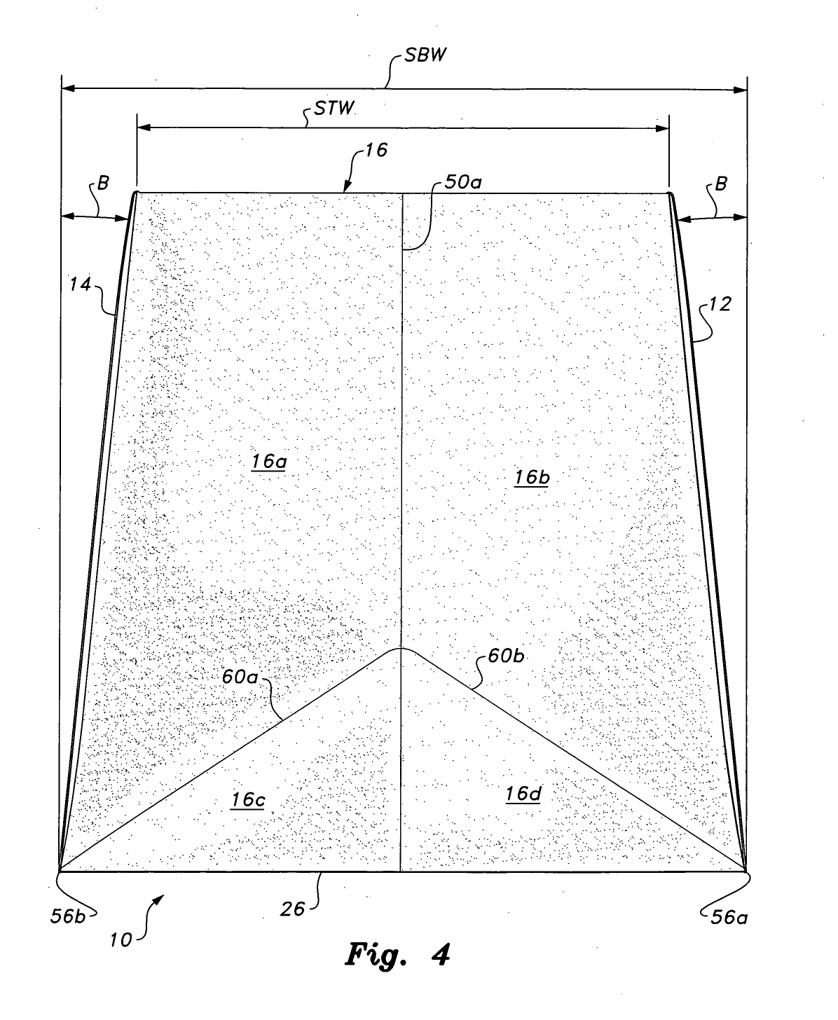

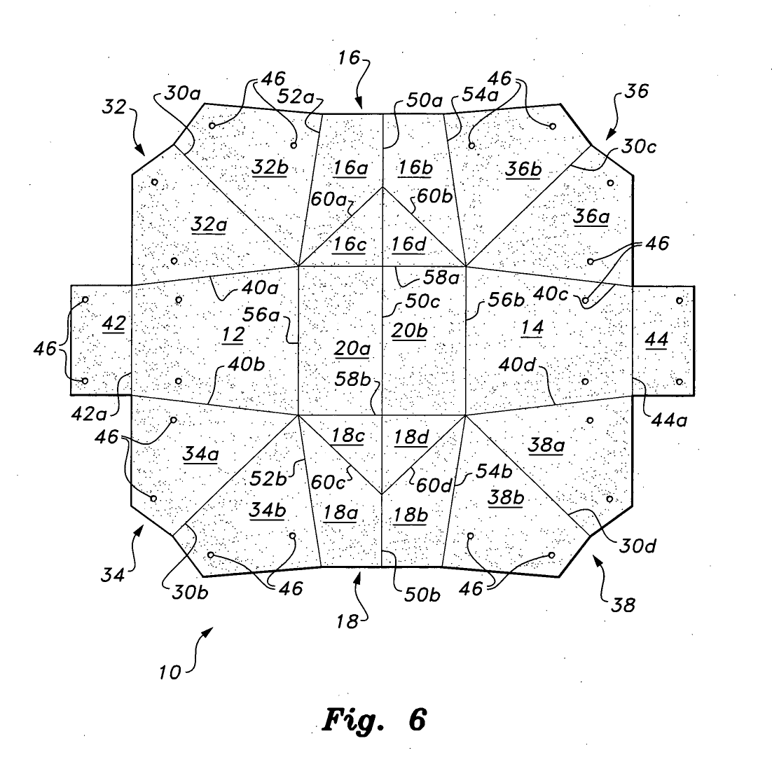

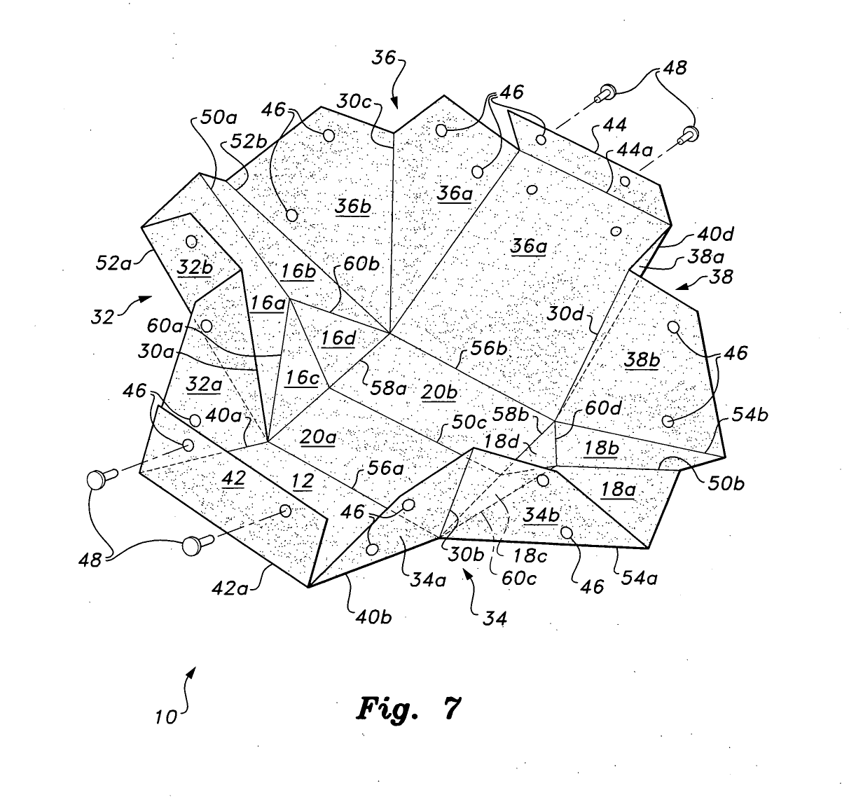

FIG. 1 provides a front and top perspective view of the container 10, illustrating three of its four upright panels and portions thereof. The container 10 generally includes a first main panel 12, an opposite second main panel 14 (shown in the rear perspective view of FIG. 2), a first side panel 16 comprising first side panel upper portions 16a, 16b and first side panel lower portions 16c, 16d (shown in FIG. 4), an opposite second side panel 18 comprising second side panel upper portions 18a, 18b and second side panel lower portions 18c, 18d, and a bottom panel 20 comprising bottom panel portions 20a, 20b (shown in the container patterns of FIGS. 6 and 7).

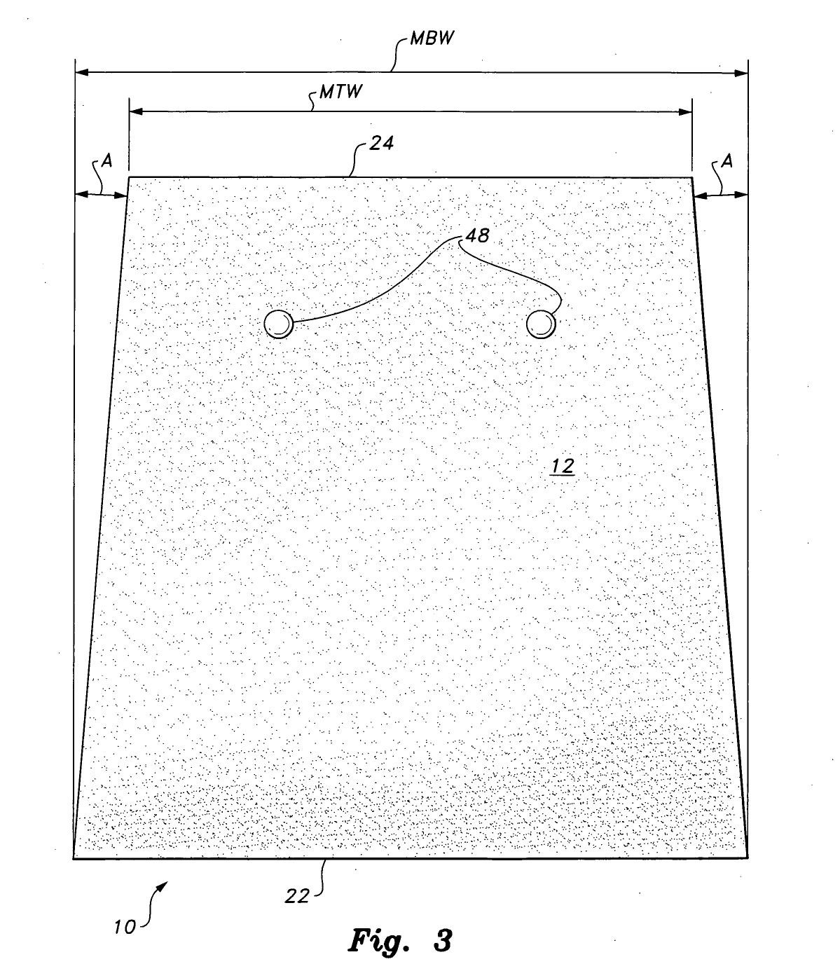

The two front panels 12 and 14 and the two side panels 16 and 18 each have the form of a trapezoid, as shown clearly in FIGS. 3 (front panel 12) and 4 (first side panel 16). The width or span MBW of the main panel base edge 22, shown in FIG. 3, is somewhat greater than the width or span MTW of the parallel main panel top edge 24, with the two side panels sloping upwardly and inwardly as shown by the two equal side angles A. Similarly, the width or span SBW of the side panel base edge 26 is somewhat greater than the width or span STW of the parallel side panel top edge 28, as shown in FIG. 4, with the two main panels sloping inwardly and upwardly as indicated by the two equal main panel angles B.

It will be seen that the main panel slope angles B may be identical to the side panel slope angles A, if so desired, or different slope angles may be used for the main panel slope angles A as opposed to the side panel slope angles B, depending upon the specific angles or orientations of the folds along which the various panels 12 through 18 are formed. The trapezoidal shapes of the four panels 12 through 18 are advantageous in that the relatively wider bottom panel 20 provides a relatively larger surface area for greater stability and the relatively larger volume in the lower portion of the container 10 results in a lower center of gravity for the container when it is filled, as noted further above.

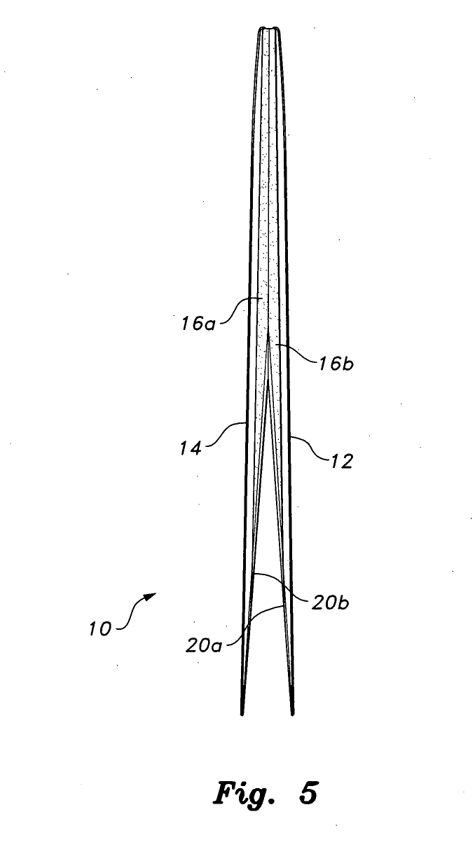

The two side panels 16, 18 and the bottom panel 20 are each divided into a series of panel portions, as noted further above. This allows the side panels and the bottom panel to be folded together, with the two main panels 12 and 14 closing toward one another as the empty container 10 is folded for storage as shown in FIG. 5 of the drawings. The folding capability of the container 10 allows considerably more such containers to be packed for shipping or storage, than would be the case with non-folding containers having rigid walls or panels.

FIGS. 6 and 7 respectively illustrate a flat pattern for the container 10 with its various fold lines and panels, and a partially folded container showing the folding process. The various folds may be considered to be of two types, depending upon whether they are intended to be permanently folded and remain folded whether the container 10 is opened or folded for storage, or whether they are intended to allow the various panels and panel portions to selectively fold inwardly for storage or to open for use of the container. There are a number of permanent or “fixed” folds, i.e., those folds that when once completed, do not unfold, flex, or bend again as the container 10 is opened and folded closed. Four of these fixed folds, i.e., fixed folds 30a through 30d, extend outwardly and generally diagonally from the lower corners defined by the four upright panels 12 through 18 and the bottom 20. These four fixed folds 30a through 30d generally bisect their respective intermediate panels, i.e., the panels extending between the adjacent upright panels 12 through 18 of the container 10.

The first and second intermediate panels 32 and 34 extend to each side of the first main panel 12 to the respective first and second side panels 16 and 18, while the third and fourth intermediate panels 36 and 38 extend to each side of the second main panel 14 to the first and second side panels. The first fixed fold 30a generally bisects the first intermediate panel 32 into its two portions 32a and 32b, while the second fixed fold 30b generally bisects the second intermediate panel 34 into its two portions 34a and 34b. The third and fourth fixed folds 30c and 30d are formed similarly, and generally bisect the respective third and fourth intermediate panels 36 and 38 into their respective portions 36a, 36b and 38a, 38b.

In addition to the above fixed folds 30a through 30d, there are four fixed folds 40a through 40d that define the lateral edges of the first and second main panels 12 and 14. These four main panel edge folds 40a through 40d are fixed, i.e., they do not open again once folded regardless of the opened or folded state of the container 10. This is due to the folding of the intermediate panels 32 through 38 to draw the main panels 12 and 14 and the side panels 16 and 18 together permanently along their common edges. It will be noted that the fixed folds defining the lateral edges of each of the main panels 12 and 14 converge toward one another from the bottom panel 20 to the upper edges of the respective panels, in order to form the basic trapezoidal solid or pyramidal frustum shape of the container 10. The four intermediate panel portions 32a, 32b and 34a, 34b are folded together to lie immediately adjacent to the inner surface of the first main panel 12, while the opposite four intermediate panel portions 36a, 36b and 38a, 38b are folded together to lie immediately adjacent to the inner surface of the second main panel 14.

The gathered intermediate panel portions 32a, 32b and 34a, 34b are secured to the inner surface of the first main panel 12 by a retaining flap 42 extending from the upper edge of the first main panel, with the retaining flap 42 folded inwardly along the fixed fold line 42a to capture the upper edges of the four intermediate panel portions 32a, 32b, 34a, and 34b between the first main panel 12 and its retaining flap 42. The opposite gathered intermediate panel portions 36a, 36b and 38a, 38b are similarly secured to the inner surface of the second main panel 14 by a retaining flap 44 that is folded inwardly from the upper edge of the second main panel 14 along the fixed fold line 44a. The result is generally like the container 10 shown in FIG. 1, with the container 10 of FIG. 1 also showing many of the hinge fold lines enabling the container to be folded flat for transport or storage.

The retaining flaps 42 and 44 and corresponding intermediate panel portions 32a through 38b may be secured to their respective first and second main panels 12 and 14 by any practicable means as desired, e.g., adhesives, heat welding of the material, etc. In the exemplary container 10 described herein, a plurality of fastener passages 46 are formed through the upper portions of the first and second main panels 12 and 14, their corresponding intermediate panel retaining flaps 42 and 44, and the intermediate panel portions 32a through 38b. Rivets 48 or other suitable mechanical fasteners are permanently installed through aligned and corresponding holes or passages 46 after the various fixed folds have been made, to complete the basic container 10.

In addition to the various fixed folds described above, the container 10 includes a number of hinge folds, i.e., folds that allow the various panels of the container to hinge or fold back and forth to open and close the container as desired. A central fold line comprising a first side panel central hinge fold 50a, opposite second side panel central hinge fold 50b, and a bottom hinge fold 50c, extends across the container sheet to bisect the container, as shown in FIG. 6 of the drawings. These hinge fold lines 50a through 50c allow the corresponding side panel portions 16a, 16b and 18a, 18b and the bottom panel portions 20a, 20b to be folded inwardly together for folding the container.

Additional hinge fold lines 52a and 52b extend from the corners of the first and second main panels 12 and 14 and the first side panel 16, with corresponding hinge fold lines 54a and 54b extending from the corners of the first and second main panels and the second side panel 18. These hinge fold lines 52a through 54b define the outer edges of the two side panels 16 and 18 with their corresponding intermediate panels, and allow the side panel portions to fold inwardly together along their respective central hinge fold lines 50a and 50b. It will be noted that the two side panel hinge folds 52a, 54a of the first side panel 16 converge toward one another from the bottom panel corners to the upper edge, to form a trapezoidal shape for the side panel 16. The corresponding side panel hinge folds 52b, 54b of the second side panel 18 converge similarly to form the trapezoidal shape of the second side panel 18.

The bottom panel comprising bottom panel portions 20a and 20b is defined by respective first and second bottom edge hinge fold lines 56a and 56b, respectively extending between the first main panel 12 and its adjacent bottom panel portion 20a and the second main panel 14 and adjacent bottom panel portion 20b. Third and fourth bottom edge hinge fold lines 58a and 58b extend across the opposite ends of the bottom panel 20, respectively defining the edges between the bottom panel and the first end panel 16 and the bottom panel and the second end panel 18.

In addition to the above hinge fold lines 50a through 56b, diagonal fold lines 60a through 60d extend from the four corners of the bottom panel 20 to intermediate points along the central fold lines 50a and 50b of the respective side panels 16 and 18. These diagonal fold lines 60a through 60d allow the triangular lower panel portions 16a through 18d of the side panels 16 and 18 to fold upwardly over the inwardly folding bottom panel portions 20a and 20b, simultaneously as the side panel portions 16a, 16b and 18a, 18b are folding inwardly. The inward folding of the major portions of the two side panels 16 and 18 and the bottom panel 20, result in the folded container 10 having a projected area very little greater than that of either of its main panels 12 or 14 when folded, with only a slight amount of the triangular lower panel portions 16a through 18d projecting from the lower sides of the trapezoidal form of the main panels.

FIG. 1 of the drawings shows the container 10 in a substantially open state, with the upper portions of the two side panels 16 and 16 folded slightly inwardly. The internal volume of the container 10 approaches its maximum in this condition, with the weight of any liquid or dry goods filling the container pushing the upper portions of the sidewalls outwardly to obtain the maximum volume.

FIG. 2 of the drawings provides an illustration of the container 10 in a partially folded state. In FIG. 2, the two side panels 16 and 18 have been folded partially inwardly, with the two portions of each panel forming approximately a 45 degree interior angle with the corresponding first and second main panels 12 and 14. Simultaneously with the above the bottom panel 20 is folded upwardly, with the two portions 20a and 20b reducing the included angle between the bottom portions and the corresponding main panels 12 and 14. The two side panels 16 and 18 and the bottom panel 20 may all be folded inwardly between the two main panels 12 and 14, due to the upward folding of the smaller triangular panels 16a, 16b and 18a, 18b along their respective diagonal hinge fold lines 60a through 60d. As the side panel portions 16a, 16b and 18a, 18b and the bottom panel portions 20a, 20b close toward their opposite members, the first and second main panels 12 and 14 are simultaneously drawn toward one another, thus reducing the thickness of the folded container 10 between the two main panels, generally as shown in FIG. 5 of the drawings.

The container 10 is preferably formed of a single seamless sheet of semi-rigid material, e.g., a sheet of liquid-impervious plastic or the like having some flexibility but also having sufficient stiffness to hold its shape, i.e., unlike a flaccid thin sheet of rubber or the like. Thus, the container 10 cannot collapse under its own weight or the weight of goods or materials placed therein, but rather deliberately folds along the various hinge fold lines as illustrated in the various drawings and described further above. The various fixed fold lines and hinge fold lines may be scored or otherwise formed on the sheet forming the container 10 to facilitate folding along those lines. Preferably the material used to form the container 10 has high fatigue resistance, which property is well known in certain plastics. This allows the container 10 to be opened or deployed for use and then folded for storage and/or transport innumerable times without tearing or otherwise opening along any of the hinged fold lines as they are repeatedly opened and closed during the use of the container.

It is to be understood that the present invention is not limited to the embodiments described above, but encompasses any and all embodiments within the scope of the following claims.

I claim:

1. A folding container, comprising:
mutually opposed first and second main panels;
mutually opposed first and second side panels, each of the first and second main panels and each of the first and second side panels having a trapezoidal shape with a base edge and a top edge, the top edge being parallel to and shorter than the base edge;
a bottom panel, the first and second main panels, first and second side panels, and bottom panel all being formed of a single seamless sheet of material folded to form the container.

2. The folding container according to claim 1, wherein each of the side panels and the bottom panel are bisected by a hinge fold line, each of the side panels and the bottom panel selectively folding inwardly between the first and second main panels along the respective hinge fold line, the first and second main panels drawing together as the side panels and bottom panel fold inwardly therebetween.

3. A method of forming a folding container using the apparatus of claim 1, comprising the steps of:
forming a plurality of fixed fold lines on the sheet, the fixed fold lines defining the first and second main panels and a plurality of intermediate portions disposed between respective adjacent main and side panels;
forming a plurality of hinge fold lines on the sheet, the hinge fold lines defining the first and second side panels, the bottom panel, and folding first and second side panel portions and bottom panel portions;
folding the intermediate portions inwardly about their respective fixed fold lines, thereby drawing adjacent edges of respective main panels and side it panels together; and
securing the intermediate portions to the respective main panels.

4. The method of forming a folding container according to claim 3, further including the steps of:
forming the mutually opposed fixed folds defining the laterally opposite edges of each of the main panels to merge toward one another from the bottom panel to an upper edge opposite the bottom panel, thereby defining a trapezoidal shape for each of the main panels; and
forming the mutually opposed hinge folds defining the laterally opposite edge of each of the side panels to merge toward one another from the bottom panel to an upper edge opposite the bottom panel, thereby defining a trapezoidal shape for each of the side panels.

5. The method of forming a folding container according to claim 3, further including the steps of:
extending an upper edge flap from the upper edge of each of the main panels;
folding each upper edge flap inwardly from its respective main panel and capturing the respective intermediate panels therebetween; and
installing a plurality of mechanical fasteners through the upper portion of each main panel, its respective intermediate panels, and respective upper edge flap, thereby securing each upper edge flap to its respective intermediate panels and main panel.

6. The folding container according to claim 1, further including:
a plurality of intermediate panels foldably disposed adjacent to each of the main panels;
an upper edge flap extending from the upper edge of each of the main panels, each upper edge flap being folded inwardly from its respective main panel and capturing the respective intermediate panels therebetween; and
a plurality of mechanical fasteners securing each upper edge flap to its respective intermediate panels and main panel.

7. The folding container according to claim 1, wherein the single seamless sheet of material is a semi-rigid, liquid impervious sheet.

8. The folding container according to claim 1, wherein the single seamless sheet of material is plastic.

9. A folding container, comprising:
mutually opposed first and second main panels;
mutually opposed first and second side panels;
a bottom panel, the first and second main panels, first and second side panels, and bottom panel all being formed of a single seamless sheet of material folded to form the container, each of the side panels and the bottom panel being bisected by a hinge fold line, each of the side panels and the bottom panel selectively folding inwardly between the first and second main panels along the respective hinge fold line, the first and second main panels drawing together as the side panels and bottom panel fold inwardly therebetween.

10. The folding container according to claim 9, wherein each of the first and second main panels and each of the first and second side panels has a trapezoidal shape with a base edge and a top edge, the top edge being parallel to and shorter than the base edge.

11. A method of forming a folding container using the apparatus of claim 9, comprising the steps of:
forming a plurality of fixed fold lines on the sheet, the fixed fold lines defining the first and second main panels and a plurality of intermediate portions disposed between respective adjacent main and side panels;
forming a plurality of hinge fold lines on the sheet, the hinge fold lines defining the first and second side panels, the bottom panel, and folding first and second side panel portions and bottom panel portions;
folding the intermediate portions inwardly about their respective fixed fold lines, thereby drawing adjacent edges of respective main panels and side panels together; and
securing the intermediate portions to the respective main panels.

12. The method of forming a folding container according to claim 11, further including the steps of:
forming the mutually opposed fixed folds defining the laterally opposite edges of each of the main panels to merge toward one another from the bottom panel to an upper edge opposite the bottom panel, thereby defining a trapezoidal shape for each of the main panels; and
forming the mutually opposed hinge folds defining the laterally opposite edge of each of the side panels to merge toward one another from the bottom panel to an upper edge opposite the bottom panel, thereby defining a trapezoidal shape for each of the side panels.

13. The method of forming a folding container according to claim 11, further including the steps of:
extending an upper edge flap from the upper edge of each of the main panels;
folding each upper edge flap inwardly from its respective main panel and capturing the respective intermediate panels therebetween; and
installing a plurality of mechanical fasteners through the upper portion of each main panel, its respective intermediate panels, and respective upper edge flap, thereby securing each upper edge flap to its respective intermediate panels and main panel.

14. The folding container according to claim 9, further including:
a plurality of intermediate panels foldably disposed adjacent to each of the main panels;
an upper edge flap extending from the upper edge of each of the main panels, each of the upper edge flaps being folded inwardly from its respective main panel and capturing the respective intermediate panels therebetween; and
a plurality of mechanical fasteners securing each upper edge flap to its respective intermediate panels and main panel.

15. The folding container according to claim 9, wherein the single seamless sheet of material is a semi-rigid, liquid impervious sheet.

16. The folding container according to claim 9, wherein the single seamless sheet of material is plastic.

17. A method of forming a folding container, comprising the steps of:
providing a single sheet of seamless material;
forming a plurality of fixed fold lines on the sheet, the fixed fold lines defining the first and second main panels and a plurality of intermediate portions disposed between respective adjacent main and side panels;
forming a plurality of hinge fold lines on the sheet, the hinge fold lines defining the first and second side panels, the bottom panel, and folding first and second side panel portions and bottom panel portions;
folding the intermediate portions inwardly about their respective fixed fold lines, thereby drawing adjacent edges of respective main panels and side panels together; and
securing the intermediate portions to the respective main panels.

18. The method of forming a folding container according to claim 17, further including the steps of:
forming the mutually opposed fixed folds defining the laterally opposite edges of each of the main panels to merge toward one another from the bottom panel to an upper edge opposite the bottom panel, thereby defining a trapezoidal shape for each of the main panels; and
forming the mutually opposed hinge folds defining the laterally opposite edge of each of the side panels to merge toward one another from the bottom panel to an upper edge opposite the bottom panel, thereby defining a trapezoidal shape for each of the side panels.

19. The method of forming a folding container according to claim 17, further including the steps of:
extending an upper edge flap from the upper edge of each of the main panels;
folding each upper edge flap inwardly from its respective main panel and capturing the respective intermediate panels therebetween; and
installing a plurality of mechanical fasteners through the upper portion of each main panel, its respective intermediate panels, and respective upper edge flap, thereby securing each upper edge flap to its respective intermediate panels and main panel.
